(19) United States
(12) Patent Application Publication
(10) Pub. No.: US 2008/0203893 A1
(43) Pub. Date: Aug. 28, 2008

(54) Light-Emitting Device

(75) Inventors: Masahiro Sakai, Kyoto (JP); Seigo Shiraishi, Osaka (JP); Takehiro Zukawa, Osaka (JP); Kojiro Okuyama, Nara (JP); Junichi Hibino, Kyoto (JP); Kazuhiko Sugimoto, Kyoto (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 11/910,832

(22) PCT Filed: Apr. 6, 2006
(86) PCT No.: PCT/JP2006/307373

§ 371 Date: Oct. 5, 2007

(30) Foreign Application Priority Data
Apr. 6, 2005 (JP) 2005-109790
Apr. 8, 2005 (JP) 2005-112280

(51) Int. Cl. H01J 1/62; H01J 17/49

(52) U.S. Cl. 313/486; 313/582

(57) ABSTRACT

The present invention is a light-emitting device which is provided with a phosphor layer containing a blue phosphor, wherein the phosphor layer includes an aluminate phosphor, as the blue phosphor, that contains Ba, Sr, Eu, Mg, Al and O as constituting elements at an atom-number ratio Ba:Sr:Eu:Mg:Al:O=p:q:r:1:w:17 wherein 0.70≦p≦0.95, 0≦q≦0.15, 0.05≦r≦0.20, p+q+r≧1, and 9.8≦w≦10.5 are satisfied, and a value of a linear coupling function s represented by a formula:

s=−11622+2043.07Lₐ+199.24L₁−116.91L₂

is 1 or less, when a lattice constant is Lₐ(Å), an interatomic distance between Al(2) and O(5) is L₁(Å), and an interatomic distance between Al(1) and O(4) is L₂(Å), which are obtained by an X-ray crystal structure analysis assuming that the aluminate phosphor belongs to a space group P6₃/mmc.

### TECHNICAL FIELD

The present invention relates to a light-emitting device that contains an aluminate phosphor as a blue phosphor in a phosphor layer.

### BACKGROUND ART

As a blue phosphor of a light-emitting device such as a plasma display panel (PDP), an alkaline earth aluminate phosphor (hereinafter, this phosphor may be simply referred to as “aluminate phosphor”), which is activated with europium and is so-called BAM:Eu, such as BaMgAl₁₀O₁₇:Eu and (Ba,Sr)MgAl₁₀O₁₇:Eu, has been drawing attention. This is because the aluminate phosphor is superior in a property of emitting visible light under vacuum ultraviolet ray excitation to other blue phosphors.

A phosphor layer of the PDP or the like has been produced by mixing a phosphor and a binder to prepare slurry, applying the slurry onto a surface of a substrate such as glass, and then baking the substrate.

In the meanwhile, when the aluminate phosphor is used, a wavelength conversion efficiency greatly degrades over time under some conditions of use. In order to prevent this, in JP-A-S61-254689, the method has been proposed wherein 5 mol % or less of gadolinium (Gd) is added to a phosphor starting material. In JP-A-2000-34478, the method has been proposed that includes coating a surface of phosphor particles with a silicate of divalent metal such as alkaline earth metal. In JP-A-H10-330746, the method has been proposed that includes coating a surface of phosphor particles with an oxide of antimony (Sb). In JP-A-2002-180043, the method has been proposed that includes mixing a starting material and a fusing agent such as AlF₃, firing the resultant starting material mixture in the air at 1000° C. for 1 hour, and then firing the mixture under the atmosphere of mixed gas of N₂—H₂ at 1550° C. for 3 hours to adjust a lattice constant L_{c} of a phosphor crystal to a range of 2.2625 nm to 2.2640 nm (22.625 Å to 22.640 Å).

However, although by the methods described in JP-A-S61-254689 and JP-A-2000-378 a certain effect of inhibiting thermal degradation during a production process is obtained, the methods can not sufficiently prevent degradation of properties caused by vacuum ultraviolet ray irradiation for aging or image display.

Further, even though the method described in JP-A-10-330746 is employed, it is difficult in itself to coat the phosphor evenly with the Sb oxide film and furthermore, there is a problem that a chromaticity change and a luminance retaining rate show an antagonistic relation.

Furthermore, even though the technique described in JP-A-2002-180043 is employed, for example, heating in the air at 500° C. for 15 min brings 5% or more of luminance degradation, and the method has not solved the problem of degradation of the properties under some conditions of use yet.

In addition, with respect to a PDP that contains the above-mentioned aluminate phosphor in a phosphor layer, a problem called a burn-in phenomenon occurs. This burn-in phenomenon is caused by the fact that a luminance retaining rate of the aluminate phosphor decreases more easily than that of other phosphors, which are a green phosphor and a red phosphor, contained in the phosphor layers. This burn-in phenomenon means the state that a certain residual image has been displayed that looks as if a screen were burned in due to a change from an initial color balance with long-term image display, that is to say it means the state that an image that loses a blue color combination has been displayed.

The present invention has achieved a solution to the above problems, and it is an object of the present invention to provide a light-emitting device which is provided with a phosphor layer including a blue phosphor and has an excellent luminance retaining rate and chromaticity retaining rate although an aluminate phosphor is used in the light-emitting device. It is a further object of the present invention to provide a plasma display panel having an excellent display performance by preventing the occurrence of the burn-in phenomenon caused by time degradation of the aluminate phosphor.

### DISCLOSURE OF INVENTION

The light-emitting device of the present invention is a light-emitting device that is provided with a phosphor layer containing a blue phosphor,

wherein the phosphor layer includes an aluminate phosphor, as the blue phosphor, that contains Ba, Sr, Eu, Mg, Al and O as constituting elements at an atom-number ratio Ba:Sr:Eu:MgAl:O=p:q:r:1:w:17 wherein 0.70≦p≦0.95, 0≦q≦0.15, 0.05≦r≦0.20, p+q+r≧1, and 9.8≦w≦10.5 are satisfied, and

a value of a linear coupling function s represented by a formula:

s=−11622+2043.07Lₐ+199.24L₁−116.91L₂

is 1 or less, when a lattice constant is Lₐ(Å), an interatomic distance between Al(2) and O(5) is L₁(Å), and an interatomic distance between Al(1) and O(4) is L₂(Å), which are obtained by an X-ray crystal structure analysis assuming that the aluminate phosphor belongs to a space group P6₃/mmc, wherein the Al(2) is the aluminum that is in the 4f site and the polarization coordinate z of which is approximately 0.17, the O(5) is the oxygen that is in the 12k site and is closest to the Al(2), the Al(1) is the aluminum that is in the 4f site and a polarization coordinate z of which is approximately 0.02, and the O(4) is the oxygen that is in the 12k site and is closest to the Al(1).

This light-emitting device has an excellent luminance retaining rate and chromaticity retaining rate, although the aluminate phosphor is used.

This light-emitting device is a light-emitting apparatus that is provided with the phosphor layer containing the blue phosphor and preferable examples thereof include a plasma display panel, a fluorescent lamp, a fluorescent panel and the like.

As a particular embodiment where the light-emitting device of the present invention is the plasma display, the plasma display has a construction comprising: a front panel, a back panel that is arranged to face the front panel, barrier ribs that define the clearance between the front panel and the back panel, a pair of electrodes that are disposed on the back panel or the front panel, a discharged gas that is present at least between the electrodes and contains xenon that emits vacuum ultraviolet ray by applying voltage between the electrodes, and phosphor layers that emit visible light induced by the vacuum ultraviolet ray, and a blue phosphor layer of the phosphor layers contains the blue phosphor. In this plasma display panel, thermal degradation of the blue phosphor during a production process is inhibited and degradation of the blue phosphor along with aging or image display is prevented. Furthermore, an occurrence of the burn-in phenomenon caused by time degradation of the aluminate phosphor is inhibited, and thus the plasma display panel has an excellent display performance.

### BRIEF DESCRIPTION OF DRAWINGS

FIG. 1 is a cross-sectional perspective view showing an example of a PDP of the present invention.

FIG. 2 is a graph showing a relation between a wavelength of X-ray and shift n parameters t₀ and t₁.

FIG. 3 is a graph showing a scheme of adjusted atmosphere temperature during reduction firing of an aluminate phosphor.

FIG. 4 is a graph showing the relation between a value of a linear coupling function s and a luminance retaining rate of an aluminate phosphor.

### BEST MODE FOR CARRYING OUT THE INVENTION

The light-emitting device of the present invention is provided with a phosphor layer containing a blue phosphor, and this phosphor layer includes an aluminate phosphor that contains Ba, Sr, Eu, Mg, Al and O as constituting elements at an atom-number ratio Ba:Sr:Eu:Mg:Al:O=p:q:r:1:w:17 wherein 0.70≦p≦0.95, 0≦q≦0.15, 0.05≦r≦0.20, p+q+r≧1, and 9.8≦w≦10.5 are satisfied.

It should be noted that the above constituting elements may be contained Just in a crystal of the aluminate phosphor, and the elements may be incorporated in the crystal lattice or intrude in the space between the lattice.

Moreover, in the present invention, a value of a linear coupling function s represented by a formula:

s=−11622+2043.07Lₐ+199.24L₁−116.91L₂

is 1 or less, when a lattice constant is Lₐ(Å), an interatomic distance between Al(2) and O(5) is L₁(Å), and an interatomic distance between Al(1) and O(4) is L₂(Å), which are obtained by an X-ray crystal structure analysis assuming that the aluminate phosphor belongs to a space group P6₃/mmc. In this regard, the Al(2) is the aluminum that is in the 4f site and the polarization coordinate z of which is approximately 0.17. The O(5) is the oxygen that is in the 12k site and is closest to the Al(2). The Al(1) is the aluminum that is in the 4f site and a polarization coordinate z of which is approximately 0.02. The O(4) is the oxygen that is in the 12k site and is closest to the Al(1).

It is conventionally considered that a resistance to the time degradation of the aluminate phosphor along with image display of a PDP or the like has a strong relation with a lattice constant L_{c}. In other words, it is considered that the resistance to the time degradation with image display becomes higher as L_{c} is smaller (see e.g., JP-A-2002-180043).

However, according to the study of the inventors of the present invention, it is not actually concluded that the resistance to the time degradation of the aluminate phosphor along with image display has a strong relation with a lattice constant L_{c}. The first reason is as follows. The value of L_{c} can be reduced by replacing a part of Ba site by Sr, while the fact that an ion radius of Sr is smaller than that of Ba is utilized. In this case, however, the resistance to the time degradation along with image display is hardly improved. The second reason is as follows. The value of L_{c} can be reduced by increasing an amount of activated Eu, while the fact that an ion radius of Eu is smaller than that of Ba is utilized. However, the resistance to the time degradation along with image display has an optimum value at a certain amount of activated Eu, and the resistance to the time degradation does not improve more, even though the amount of activated Eu is increased to the higher amount.

The inventors of the present invention have found that a function which shows a strong relation with the time degradation of the aluminate phosphor along with image display is the above-mentioned linear coupling function s, and that controlling the value of the linear coupling function s to be 1 or less can prevent the time degradation of the aluminate phosphor. It should be noted that Lₐ, L₁, and L₂ in the function can be determined by the known X-ray diffraction analysis and Rietveld analysis. In the embodiment of the present invention, each of them is calculated, assuming that a crystal structure of the aluminate phosphor belongs to a space group P6₃/mmc (space group No. 194) described in International Tables for X-ray Crystallography Volume A.

A PDP or the like exerting an excellent display performance, which can retain good color even after long-time driving, that is to say, retain a proper color balance for a long period to prevent an occurrence of a burn-in phenomenon, can be achieved by using this aluminate phosphor for a phosphor layer of the PDP or the like.

In addition, since the luminance of the blue phosphor layer tends not to deteriorate, there is no need to decrease the luminance of (red and green) phosphor layers other than a blue phosphor layer intentionally for the purpose of keeping a color temperature of white during the long-time driving, unlike the cases of conventional phosphors. Therefore, both the luminance of the phosphor layers of each color and the color temperature of white can be enhanced.

In the light-emitting device of the present invention, the aluminate phosphor may be substantially an aluminate phosphor that is represented by BaₚSr_{q}EuᵣMgAl_{w}O₁₇. Here, the term “substantially” means the content of the elements other than the already mentioned elements is 0.01 atom % or less. It should be noted that it is difficult to measure an oxygen amount definitely with the present technology.

Moreover, in the light-emitting device of the present invention, the aluminate phosphor may be an aluminate phosphor that consists of only BaₚSr_{q}EuᵣMgAl_{w}O₁₇.

Furthermore, in the light-emitting device of the present invention, the aluminate phosphor may be substantially an aluminate phosphor in which at least one element selected from the group consisting of Nb and W is added to BaₚSr_{q}EuᵣMgAl_{w}O₁₇, and the total amount of the at least one element may be 0.30 mol or less (preferably 0.001 mol or more) relative to 1 mol of the BaₚSr_{q}EuᵣMgAl_{w}O₁₇. According to this composition, it becomes easy to control the value of the linear coupling function s to be 1 or less. Here, the term “substantially” means the content of the elements other than the already mentioned elements is 0.01 atom % or less. It should be noted that it is difficult to measure an oxygen amount definitely with the present technology.

In addition, in the light-emitting device of the present invention, the aluminate phosphor may consist of only the aluminate phosphor in which at least one element selected from the group consisting of Nb and W is added to BaₚSr_{q}EuᵣMgAl_{w}O₁₇, and the total amount of the at least one element may be 0.30 mol or less (preferably 0.001 mol or more) relative to 1 mol of the BaₚSr_{q}EuᵣMgAl_{w}O₁₇.

Nb and W are elements effective to control the value of the linear coupling function s. W shows an effect of enhancing a reduction efficiency during reduction firing. When the addition amount of W is small, the effect of decreasing the value of the linear coupling function s becomes small. In this case, in order to control the value of the linear coupling function s to be 1 or less, it is recommended to set a reduction temperature high and furthermore, set also an air-introducing temperature high. Nb, which is the other additive element, has an effect of enhancing crystallizability during air-firing. When the addition amount of Nb is small, the effect of decreasing the value of the linear coupling function s becomes small. In this case, in order to control the value of the linear coupling function s to be 1 or less, it is recommended to set an air-firing temperature high. With respect to the addition amount of the additive elements Nb and W relative to 1 mol of BaₚSr_{q}EuᵣMgAl_{w}O₁₇, considered as a total amount when Nb and W are used in combination, the lower limit is approximately 0.001 mol. On the other hand, when the addition amount of the additive elements are large, luminance tends to be lower. Therefore, the upper limit is approximately 0.3 mol. The addition amount of the additive elements is preferably in the range of 0.01 to 0.20 mol, more preferably 0.01 to 0.03 mol, and most preferably 0.015 to 0.025 mol.

In addition, adjusting the Lₐ to fall within a range of 5.6235 Å to 5.6255 Å, the L₁ to fall within a range of 1.753 Å to 1.760 Å, and the L₂ to fall within a range of 1.865 Å to 1.880 Å, makes it relatively easy to control the value of the linear coupling function s to be 1 or less.

### <Preparation of Aluminate Phosphor>

For a synthesis of the aluminate phosphor used in the present invention, known methods such as a solid-state reaction method in which oxide, nitric acid salt or carbonate raw materials are sintered using a flux; a liquid-phase synthesis method in which a precursor of a phosphor is produced by a coprecipitation method in which organic metal salt or nitric acid salt raw materials are precipitated by hydrolysis or addition of an alkali in an aqueous solution, and then the precursor is heat-treated; a liquid spraying method in which an aqueous solution of raw materials is sprayed into a furnace that is already heated, can be employed. In this regard, it is necessary to sort out the aluminate phosphor that has those Lₐ, L₁ and L₂ which make the above-mentioned linear coupling function s 1 or less.

A synthesis method of the above aluminate phosphor will be described with an example where the aluminate phosphor is synthesized from each constituting element source by a solid-phase reaction method.

As an aluminum source, an aluminum compound that converts into alumina by firing, such as aluminum hydroxide, aluminum nitrate or aluminum halide having high purity (purity: 99.99% or more; hereinafter high purity means this purity.) may be used. Alumina having high purity also may be used. The crystal form of the alumina may be α-alumina or intermediate alumina.

As a barium source, a barium compound that converts into barium oxide by filing, such as barium hydroxide, barium carbonate, barium nitrate, barium halide or barium oxalate having high purity may be used. Barium oxide having high purity also may be used.

As a strontium source, a strontium compound that converts into strontium oxide by firing, such as strontium hydroxide, strontium carbonate, strontium nitrate, strontium halide or strontium oxalate having high purity may be used. Strontium oxide having high purity also may be used.

As a magnesium source, a magnesium compound that converts into magnesium oxide by firing, such as magnesium hydroxide, magnesium carbonate, magnesium nitrate, magnesium halide, or magnesium oxalate having high purity may be used. Magnesium oxide having high purity also may be used.

As a europium source, a europium compound that converts into europium oxide by firing, such as europium hydroxide, europium carbonate, europium nitrate, europium halide, or europium oxalate having high purity may be used. Europium oxide having high purity also may be used.

As a flux, for example, known fluxes such as AlF₃ may be used.

For example, when an aluminate phosphor having a compositional formula of Ba_{0.8}Sr_{0.1}Eu_{0.1}MgAl₁₀O₁₇ is synthesized, each of constituting element sources may be blended at the following ratio:

| | |
|---|---|
| BaCO₃ | 0.80 mol |
| SrCO₃ | 0.10 mol |
| Eu₂O₃ | 0.05 mol |
| MgCO₃ | 1.00 mol |
| Al₂O₃ | 5.00 mol |
| AlF₃ | 0.01 mol |

Each of the above constituting element sources is blended with a known V-type mixer, stirrer ball mill having a crushing function, vibration mill, or jet mill so that a mixed powder of phosphor materials is prepared. This mixed powder is fired, for example, in the air at 1200 to 1500° C. for about 2 hours and then crushed. The powder that has been crushed excessively is removed by sieving. Then, after the mixed powder is fired under a reducing atmosphere (nitrogen that contains hydrogen with 5% partial pressure) at approximately 1500° C. for about 2 hours, the reducing atmosphere is replaced with an oxidizing atmosphere (having oxygen with partial pressure of 0.5% or more, preferably 20% or more) at the same temperature, when the temperature of the atmosphere drops to 850° C. to 1050° C. The powder is allowed to stand so as to be cooled to room temperature. After that, crushing and sieving are carried out again so that the aluminate phosphor can be produced. It should be noted that in order to reduce a defect of the phosphor more, annealing further may be carried out at a temperature at which the phosphor is not resintered, for example, 1000° C. or less under an oxidizing atmosphere (nitrogen that contains oxygen with 5% partial pressure).

Here, it is necessary to sort out the aluminate phosphor that has specific values of Lₐ, L₁, and L₂, that is to say the aluminate phosphor whose value of the linear coupling function s is 1 or less, from the aluminate phosphor produced as above. In this regard, it is preferable that the aluminate phosphor to which at least one element selected from the group consisting of Nb and W is added in the total amount of 0.30 mol or less is used, since it makes easy to control the above linear coupling function s to be 1 or less, and as a result, the effort of sorting out is to be saved. The at least one element may be added during mixing of raw materials or before firing under the reducing atmosphere. The element may be added as a simple substance or an oxide. The addition amount is preferably 0.001 mol or more. It should be noted that when the element is added in the amount over 0.30 mol, the luminance of the phosphor may be lowered. Therefore, the addition amount should be preferably set in the above range. It should be noted that when the addition amount of W is small, it is recommended to set the reduction temperature high and furthermore, set also the air-introducing temperature high in order to control the value of the linear coupling function s to be 1 or less. When the addition amount of Nb is small, it is recommended to set the air-firing temperature high in order to control the value of the linear coupling function s to be 1 or less.

When the aluminate phosphor is produced by the liquid phase synthesis method, organic metal compounds (e.g., organic metal salts) containing elements that constitute the phosphor, such as metal alkoxides, acetylacetone metal complexes, and nitric acid salts, are dissolved in water. Then, the compounds are hydrolyzed to yield a coprecipitate (hydrate) and the coprecipitate is crystallized in an autoclave, more specifically, is subjected to a hydrothermal synthesis, fired in the air, or sprayed into a high temperature furnace, so that a powder is obtained. After that, the aluminate phosphor can be prepared in a manner similar to the above-mentioned solid-state reaction method, for example, by filing under a reducing atmosphere and the like.

As another production method, a method in which a mixed powder of phosphor materials is fired under a reducing atmosphere in a similar fashion, then Eu₂O₃ is added, and the resultant powder is subjected to a heat treatment. Further, a method in which a surface of a mixed powder is subjected to an oxidation treatment may be employed. This oxidation treatment of the surface may be carried out, for example, by a plasma processing or ultraviolet irradiation under an atmosphere containing oxygen, ozone, or oxygen radicals.

### <Crystal Structure Analysis>

Hereinafter, a specific method for calculating a lattice constant Lₐ and interatomic distances L₁ and L₂ will be described in detail.

For a measurement of the lattice constant and the interatomic distances, a powder X-ray diffraction and Rietveld analysis are used. For the powder X-ray diffraction measurement, BL19B2 powder X-ray diffraction equipment (Debye-Scherrer optical system using an imaging plate; hereinafter referred to as BL19 diffraction equipment) in the large-scale synchrotron radiation facility, SPring-8 is used. For the Rietveld analysis, RIETAN-2000 program (Rev. 2.3.9 or later revision; hereinafter referred to as RIETAN) is used (see NAKAI Izumi, IZUMI Fujio, “Funmatu X-sen kaiseki-no-jissai—Rietveld hou nyumon (Practice of powder X-ray analysis—introduction to Rietveld method) Discussion Group of X-Ray Analysis, the Japan Society for Analytical Chemistry, Asakura Publishing, 2002, and http://homepage.mac.com/fujioizumi/).

First, an incident x-ray wavelength is determined using CeO₂ powder (SRM No. 674a) of NIST (National Institute of Standards and Technology) with a lattice constant of 5.4111 Å. The powder is tightly packed into a Lindemann glass capillary with an internal diameter of 200 μm. The incident X-ray wavelength is set to be approximately 0.773 Å using the BL19 diffraction equipment. While the sample is spun using a goniometer, a diffraction intensity is recorded on an imaging plate. Measuring time is to be determined, paying attention to keep the imaging plate unsaturated, and, for example is 2 minutes. The imaging plate is developed and an X-ray diffraction spectrum is read out.

Next, the incident X-ray wavelength is precisely determined by the Rietveld analysis with the lattice constant fixed. The obtained X-ray diffraction spectrum is analyzed based on ICSD (Inorganic Crystal Structure Database) #2875. In this regard, XLMDX (hereinafter represented as λ) is set to be 0.771, 0.772, 0.773, 0.774 and 0.775 Å, and the analysis is carried out on each of them. The analysis conditions of these are shown in Table 1. It should be noted that a refinement is carried out within the range 2θ=6 to 60°.

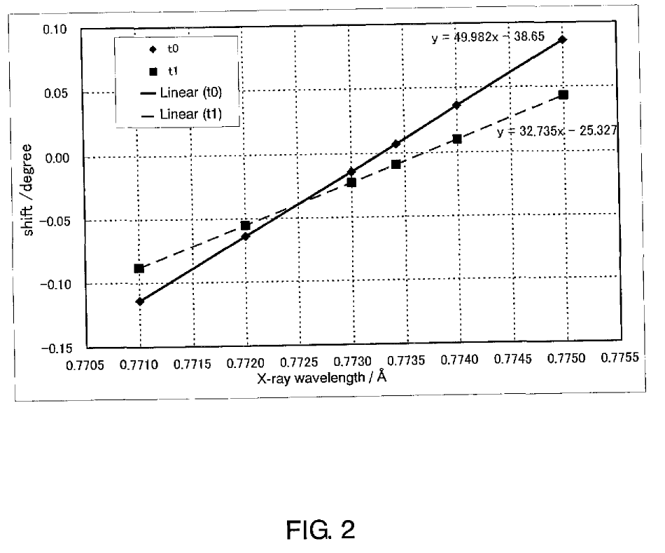

An example of a relationship between shift n parameters t₀, t₁ and λ is shown in FIG. 2. There is almost a linear relationship between t₀ and t₁, and λ. Here, a linear approximation formula tₙ=mₙλ·Cₙ (n=0, 1, mₙ is a slope, and Cₙ is a constant), which relates to λ and t₀, t₁, is calculated. Using the calculation results, a refined incident X-ray wavelength λᵣ is calculated from the following formula:

λᵣ=(C₀/m₀+0.5C₁/m₁)/1.5

Next, the X-ray diffraction measurement of the aluminate phosphor and the Rietveld analysis are carried out.

The X-ray diffraction measurement is carried out as in the case of CeO₂. In this regard, the measuring time is to be determined, paying attention to keep the imaging plate unsaturated, and, for example is 5 minutes. Then, the Rietveld analysis is carried out under the condition shown in Table 2. In Table 2(2), the occupancy g of Ba is fixed (ID=0), but in the middle of the analysis, the occupancy g is refined (ID=1) beforehand while a displacement parameter B of Ba is fixed, and eventually the occupancy g is fixed for the analysis. M in Ba site represents a virtual ion. According to a result of an analysis of a composition ratio by an inductively-coupled plasma emission spectrometry, the virtual ion M is calculated from a mol ratio of Ba, Sr and Eu, assuming that all of Ba, Sr and Eu are divalent. Further, in the initial stage of the analysis, to is fixed. Furthermore, when attenuation parameters eta_L₀, eta_L₁, eta_H₀, and eta_H₁ are simultaneously fitted, there may be a case where they are divergent. In this case, eta_L₁, and eta_H₁ are fixed. With respect to a background, a refinement is not carried out (i.e., NRANGE=1), and a background file (extension bkg) is prepared. The background file is a file in which the intensities at the angles shown in Table 2(4) are read from each spectrum.

TABLE 1
(1)Parameter

| | |
|---|---|
| NBEAM | 2 |
| NMODE | 0 |
| XLMDX | 0.771-0.775 |
| NSURFR | 2 |
| PCOR2 | 0.05 |
| CTHM2 | 1 |
| XMUR2 | 0 |
| VNS1 | Λ-225-1 |
| LSPSYM1 | 0 |
| LPAIR1 | 0 |
| INDIV1 | 1 |
| NPROR1 | 3 |
| IHP1 | 0 |
| IKP1 | 0 |
| ILP1 | 1 |
| LSUM1 | 0 |
| IHA1 | 0 |
| IKA1 | 0 |
| ILA1 | 1 |
| NPRFN | 2 |
| NSHIFT | 4 |
| NEXC | 1 |
| NRANGE | 0 |
| PC | 7 |
| NLESQ | 0 |
| NC | 0 |
| TK | 650 |
| NDA | 1 |

(2)Initial value and setting of refinement (ID)

| | t0 | t1 | t2 | t3 | ID |
|---|---|---|---|---|---|
| shiftn | 0 | 0 | 0 | 0 | 1111 |

Lattice constant a 5.4111 (fixed)

| | | Site | | | | | |
|---|---|---|---|---|---|---|---|
| | | Occu- | Polarization | | | Displacement | Refine- |
| | | pancy | coordinate | | | parameter | ment |
| | | Wyckoff | | | | | |
| | | g | x | y | z | B | ID |
| Ce/Ce4+ | 4a | 1 | 0 | 0 | 0 | 0.19 | 0001 |
| O/O2− | 8c | 1 | 0.25 | 0.25 | 0.25 | 0.66 | 0001 |

TABLE 2
(1)Parameter

| | |
|---|---|
| NBEAM | 2 |
| NMODE | 0 |
| XLMDX | λr |
| NSURFR | 0 |
| PCOR2 | 0.05 |
| CTHM2 | 1.0 |
| XMUR2 | 0.0 |
| Phase1 | BaMgAl10O17(β-alumina) |
| VNS1 | A-194 |
| LSPSYM1 | 0 |
| LPAIR1 | 0 |
| INDIV1 | 1 |
| NPROR1 | 3 |
| IHP1 | 0 |
| IKP1 | 0 |
| ILP1 | 1 |
| LSUM1 | 0 |
| IHA1 | 0 |
| IKA1 | 0 |
| ILA1 | 1 |
| NPRFN | 2 |
| NSHIFT | 4 |
| NEXC | 1 |
| NRANGE | 1 |
| PC | 8 |
| NLESQ | 0 |
| NC | 0 |
| TK | 650.0 |
| FINC | 2.0 |

(2)Initial value and setting of refinement (ID)

| | | | | |
|---|---|---|---|---|
| t0 | t1 | t2 | t3 | ID |

| | | |
|---|---|---|
| shiftn | The initial value is determined from the result on CeO2. | 1000 |

BaMgAl10O17 (β-alumina)

| | a | c | ID |
|---|---|---|---|
| Lattice constant | 5.6253 | 22.6242 | 1010000 |

| | | Site | | | | | |
|---|---|---|---|---|---|---|---|
| | | Occupancy | Polarization coordinate | | | Displacement parameter | Refinement |
| | | Wyckoff | | | | | |
| | | g | x | y | z | B | ID |
| Mg/Mg2+ | 2a | 1.00 | 0.0000 | 0.0000 | 0.0000 | 0.4970 | 00002 |
| Ba/M | 2d | 1.00 | 0.3333 | 0.6667 | 0.7500 | 1.0597 | 00001 |
| Al(1)/Al3+ | 4f | 1.00 | 0.3333 | 0.6667 | 0.0241 | 0.4970 | 00011 |
| Al(2)/Al3+ | 4f | 1.00 | 0.3333 | 0.6667 | 0.1744 | 0.4970 | 00012 |
| Al(3)/Al3+ | 12k | 1.00 | 0.1664 | 0.3328 | 0.8939 | 0.4970 | 01212 |
| O(1)/O2− | 2c | 1.00 | 0.3333 | 0.6667 | 0.2500 | 0.3337 | 00001 |
| O(2)/O2− | 4e | 1.00 | 0.0000 | 0.0000 | 0.1450 | 0.3337 | 00012 |
| O(3)/O2− | 4f | 1.00 | 0.3333 | 0.6667 | 0.9402 | 0.3337 | 00012 |
| O(4)/O2− | 12k | 1.00 | 0.1519 | 0.3038 | 0.0521 | 0.3337 | 01212 |
| O(5)/O2− | 12k | 1.00 | 0.5026 | 1.0052 | 0.1491 | 0.3337 | 01212 |

(3)Binding condition

A(Mg,B) = A(Al1,B)
A(Al2,B) = A(Al1,B)
A(Al3,B) = A(Al1,B)
A(O2,B) = A(O1,B)
A(O3,B) = A(O1,B)
A(O4,B) = A(O1,B)
A(O5,B) = A(O1,B)
A(Al3,y) = 2.0 * A(Al3,x)
A(O4,y) = 2.0 * A(O4,x)
A(O5,y) = 2.0 * A(O5,x)

(4) Angle setting of background

7.50
8.20
10.30
11.20
12.80
13.80
15.30
17.30
18.50
18.90
20.40
22.80
24.80
25.90
27.20
29.80
30.50
32.60
34.50
36.40
37.35
39.71
41.58
44.81
46.08
47.78
51.82
52.35
56.00
58.59

As explained above, by refining Lₐ, L_{c} and the polarization coordinate of aluminate phosphor, obtained by the X-ray diffraction measurement, an interatomic distance L₁ (Å) between Al(2) and O(5), and an interatomic distance L₂(Å) between Al(1) and O(4) are calculated precisely. Consequently the aluminate phosphor having the linear coupling function s of 1 or less can be sorted out.

The phosphor layer that the light-emitting device of the present invention is provided with may contain a phosphor other than the above-mentioned blue phosphor depending on the application of the device. In other words, this phosphor layer may be a phosphor layer that contains not only a blue phosphor but also a green phosphor and/or a red phosphor.

In the present invention, a light-emitting device means a light-emitting apparatus that is provided with a phosphor layer containing a blue phosphor, and as examples thereof, a plasma display panel, a fluorescent lamp, a fluorescent panel used as a backlight etc. of a liquid crystal display device, and the like are mentioned.

Hereinafter, embodiments where the light-emitting device of the present invention is a plasma display panel, a fluorescent lamp, and a fluorescent panel will be described specifically.

### <Plasma Display Panel>

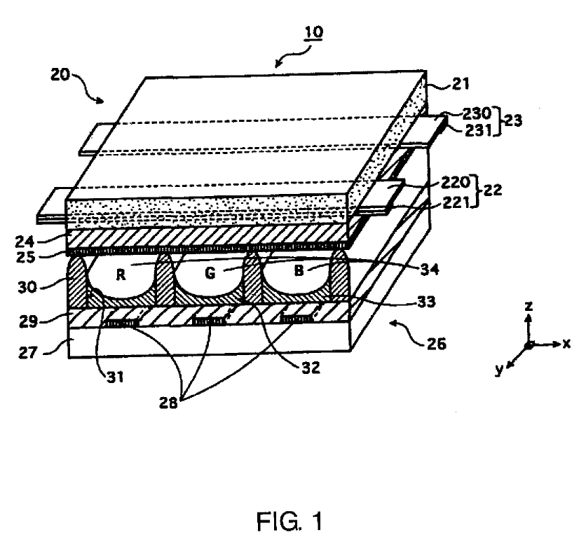

When the light-emitting device of the present invention is a plasma display panel (PDP), the PDP includes a blue phosphor layer, and the blue phosphor layer contains the above-mentioned aluminate phosphor wherein the value of the linear coupling function s is 1 or less. In this plasma display panel, thermal degradation of the blue phosphor during a production process is inhibited, while degradation of the blue phosphor along with aging and image display is prevented. In addition, an occurrence of a burn-in phenomenon caused by time degradation of the aluminate phosphor is inhibited, and the plasma display panel has an excellent display performance. Hereinafter, the PDP of the present invention will be explained with an example of an AC surface-discharge type PDP. FIG. 1 is a cross-sectional perspective view showing a principal structure of an AC surface-discharge type PDP 10. It should be noted that the PDP shown here is illustrated for convenience sake with a size that is appropriate for a specification of 1024×768 pixels, which is 42-inch class, and the present invention may be applied to other sizes and specifications as well.

As shown in FIG. 1, this PDP 10 includes a front panel 20 and a back panel 26, and these panels are arranged with their main surfaces facing each other.

The front panel 20 includes a front panel glass 21 as a front substrate, strip-shaped display electrodes (X-electrode 23, Y-electrode 22) provided on one main surface of the front panel glass 21, a front-side dielectric layer 24 having a thickness of about 30 μm covering the display electrodes, and a protective layer 25 having a thickness of about 1.0 μm provided on the front-side dielectric layer 24.

The above display electrode includes a strip-shaped transparent electrode 220 (230) with a thickness of 0.1 μm and width of 150 μm, and a bus line 221 (231) having a thickness of 7 μm and width of 95 μm and laid on the transparent electrode. A plurality of pairs of the display electrodes are disposed in the y direction, where the x direction is a longitudinal direction.

Each pair of display electrodes (X-electrode 23, Y-electrode 22) is electrically connected to a panel drive circuit (not shown) in the vicinity of the ends of the width direction (y direction) of the front panel glass 21. It should be noted that the Y-electrodes 22 are collectively connected to the panel drive circuit and the X-electrodes 23 are each independently connected to the panel drive circuit. When the Y-electrodes 22 and the certain X-electrodes 23 are fed using the panel drive circuit, a surface discharge (sustained discharge) is generated in the gap (approximately 80 μm) between the X-electrode 23 and the Y-electrode 22. The X-electrode 23 can operate as a scan electrode, and in this case, a write discharge (address discharge) can be generated between the X-electrode 23 and the after-mentioned address electrode 28.

The above-mentioned back panel 26 includes a back panel glass 27 as a back substrate, a plurality of address electrodes 28, a back-side dielectric layer 29, barrier ribs 30, and phosphor layers 31 to 33, each of which corresponds to one color of red (R), green (G), and blue (B). The phosphor layers 31 to 33 are provided so that they contact with side walls of two adjacent barrier ribs 30 and with the back-side dielectric layer 29 between the adjacent barrier ribs 30, and repeatedly disposed in sequence in the x direction.

The blue phosphor layer necessarily contains the above-mentioned aluminate phosphor in which the linear coupling function s is 1 or less. On the other hand, the red phosphor layer and the green phosphor layer contain phosphors commonly used. As a red phosphor, (Y, Gd)BO₃:Eu is exemplified. As a green phosphor, Zn₂SiO₄:Mn is exemplified.

Each phosphor layer can be formed by applying a phosphor ink in which phosphor particles are dissolved to the barrier ribs 30 and the back-side dielectric layer 29 by a known applying method such as a meniscus method and a line jet method, and drying and firing (e.g., at 500° C., for 10 min) them. The above-mentioned phosphor ink can be prepared, for example, by mixing 30% by mass of the blue phosphor with a volume average particle diameter of 2 μm, 4.5% by mass of ethyl cellulose with mass average molecular weight of about 200,000, and 65.5% by mass of butyl carbitol acetate. In this regard, it is preferable that a viscosity thereof is adjusted eventually to 2000 to 6000 cps, since the adherence of the ink to the barrier ribs 30 can be enhanced.

The address electrodes 28 are provided on the one main surface of the back panel glass 27. The back-side dielectric layer 29 is provided so as to cover the address electrodes 28. The barrier ribs 30 have a height of about 150 μm and width of about 40 μm, and the longitudinal direction is in the y direction. The barrier ribs 30 are provided on the back-side dielectric layer 29 so as to correspond to pitches of the adjacent address electrodes 28.

Each of the address electrodes 28 has a thickness of 5 μm and width of 60 μm. A plurality of address electrodes 28 are disposed in the x direction, where the y direction is a longitudinal direction. The address electrodes 28 are disposed at a certain pitch (about 150 μm). A plurality of address electrodes 28 are each independently connected to the above-mentioned panel drive circuit. Address discharge can be generated between a certain address electrodes 28 and a certain X-electrode 23 by feeding each address electrode individually.

The front panel 20 and the back panel 26 are disposed so that the address electrode 28 and the display electrode are orthogonal. Peripheral portions of both panel 20 and 26 are bonded and sealed by a frit glass sealing portion (not shown) in which the frit glass is used as a sealing member.

In an enclosed space between the front panel 20 and the back panel 26, which has been bonded and sealed by the frit glass sealing portion, a discharge gas composed of a rare gas such as He, Xe and Ne is included at a certain pressure (ordinarily about 6.7×10⁴ to 1.0×10⁵ Pa).

It should be noted that a space corresponding to a space between two adjacent barrier ribs 30 is a discharge space 34. A region where a pair of display electrodes and one address electrode 28 intersect with a discharge space 34 in between corresponds to a cell used for displaying images. It should be noted that in this embodiment, the cell pitch in the x direction is set to approximately 300 μm and the cell pitch in the y direction is set to approximately 675 μm.

When the PDP 10 is driven, a sustained discharge is generated by applying a pulse to between a pair of the display electrodes (X-electrode 23, Y-electrode 22) after an address discharge is generated by applying a pulse voltage to the certain address electrode 28 and the certain X-electrode 23 by a panel drive circuit. A prescribed image can be displayed on the front panel side by letting the phosphors contained in the phosphor layers 31 to 33 emit visible light using the ultraviolet ray with a short wavelength (resonance lines with a central wavelength of about 147 nm) thus generated.

### <Fluorescent Panel>

When the light-emitting device of the present invention is a fluorescent panel, the device is superior in luminance, a resistance to luminance degradation, and a chromaticity retaining rate to conventional fluorescent panels. This fluorescent panel can be applied for, for example, a backlight of a liquid crystal display device. Hereinafter, an example of a three-wavelength-type fluorescent tube used for a backlight of a liquid crystal display will be explained as one embodiment.

The above-mentioned aluminate phosphor is used as the blue phosphor. For a green phosphor, LaPO₄:Ce,Tb, for example, is used, and for a red phosphor, Y₂O₃:Eu, for example, is used. A phosphor ink in which powders of these phosphors and ethyl cellulose are mixed with terpineol is prepared. This phosphor ink is applied onto an inner wall of a glass tube, and dried. Then, an electrode filament is welded. After that, ethyl cellulose is burnt and the phosphors are fixed so that a phosphor layer is formed. The atmosphere inside is discharged and 700 Pa of a mixed gas of argon:mercury=1000:1 is filled inside. Metal caps are attached to both ends of the glass tube, and aging is carried out to produce a fluorescent tube. For an electrode filament, tungsten whose surface is coated with BaO should be used

### <Fluorescent Lamp>

When the light-emitting device of the present invention is a fluorescent lamp (e.g., Xe gas discharge whit fluorescent lamp), the device is superior in luminance, a resistance to luminance degradation, and a chromaticity retaining rate to conventional fluorescent lamps. This fluorescent lamp can be used even as a backlight of a liquid crystal display device. This fluorescent lamp may be constituted as the fluorescent lamp described in, for example, JP-A-2006-12770 (US patent application laid-open No. 2005/264161).

Hereinafter, a relationship between the value of the linear coupling function s of the aluminate phosphor and time degradation of fluorescence of the aluminate phosphor will be described in detail, in reference to Examples and Comparative Examples.

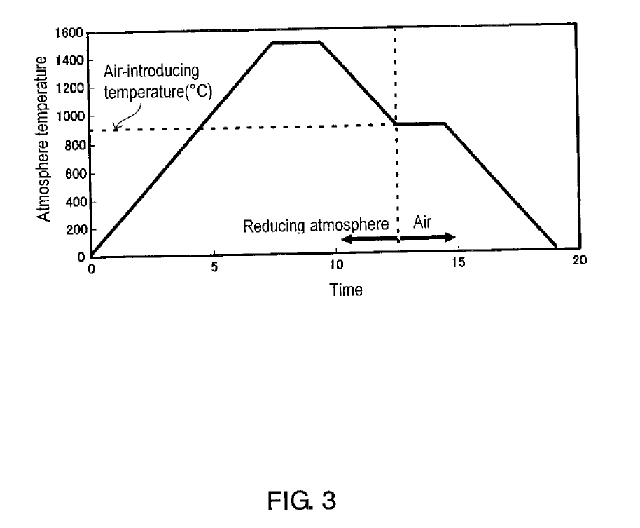

First, with respect to aluminate phosphors of Examples 1 and 2 and Comparative Examples 1 to 5, compositions, kinds of elements added for production of the aluminate phosphors, molar ratios of added elements, and production conditions such as an air-firing temperature, a reduction firing temperature, and an air-introducing temperature are shown in Table 3. It should be noted that the molar ratio of the added element means mol number of the added element to 1 mol of BaₚSr_{q}EuᵣMgAl_{w}O₁₇. In addition, a scheme of an adjusted atmosphere temperature during reduction firing of the aluminate phosphor of Example 1 is shown in FIG. 3. It should be noted that with respect to other Example and Comparative Examples, similar temperature adjustment schemes were used although an air-firing temperature and an air-introducing temperature during reduction firing were appropriately adjusted.

TABLE 3

| | Composition | | | | | Additive | Addition | Air-firing | Reduction firing | Air-introducing |
|---|---|---|---|---|---|---|---|---|---|---|
| | Ba | Sr | Eu | Mg | Al | element | amount | temperature(° C.) | temperature(° C.) | temperature(° C.) |
| Example 1 | 0.85 | 0.00 | 0.15 | 1.00 | 10.00 | W | 0.02 | 1500 | 1500 | 900 |
| Example 2 | 0.85 | 0.00 | 0.15 | 1.00 | 10.00 | Nb | 0.02 | 1450 | 1500 | 900 |
| Comparative example 1 | 0.80 | 0.10 | 0.10 | 1.00 | 10.00 | W | 0.02 | 1400 | 1500 | 850 |
| Comparative example 2 | 0.80 | 0.10 | 0.10 | 1.00 | 10.00 | Nb | 0.05 | 1450 | 1500 | 900 |
| Comparative example 3 | 0.80 | 0.10 | 0.10 | 1.00 | 10.00 | Gd | 0.03 | 1450 | 1500 | 900 |
| Comparative example 4 | 0.70 | 0.20 | 0.10 | 1.00 | 10.00 | none | 0.00 | 1400 | 1500 | 850 |
| Comparative example 5 | 0.90 | 0.00 | 0.10 | 1.00 | 10.00 | none | 0.00 | 1450 | 1500 | 600 |

Next, the values of lattice constants (a axis length) Lₐ, interatomic distances L₁ between Al(2) and O(5), interatomic distances L₂ between Al(1) and O(4) and linear coupling functions s obtained by assigning these values, of aluminate phosphors produced under the condition shown in Table 3, are shown in Table 4.

In addition, the above-mentioned AC surface-discharge type PDPs, each of which includes a blue phosphor layer formed using each aluminate phosphors, are produced. Luminance retaining rates measured after the PDPs have displayed images for about 5000 consecutive hours are also shown in table 4.

TABLE 4

| | | | | Linear coupling | Luminance retaining |
|---|---|---|---|---|---|
| | La(Å) | L₁(Å) | L₂(Å) | function s | rate/% |
| Example 1 | 5.62387 | 1.7598 | 1.8671 | 0.3000 | 99.5 |
| Example 2 | 5.62501 | 1.7539 | 1.8750 | 0.5300 | 99.3 |
| Comparative example 1 | 5.62637 | 1.7503 | 1.8807 | 1.9248 | 98.4 |
| Comparative example 2 | 5.62576 | 1.7571 | 1.8791 | 2.2207 | 98.0 |
| Comparative example 3 | 5.62575 | 1.7573 | 1.8782 | 2.3453 | 97.9 |
| Comparative example 4 | 5.62539 | 1.7606 | 1.8762 | 2.5009 | 97.4 |
| Comparative example 5 | 5.62710 | 1.7640 | 1.8727 | 7.0812 | 94.8 |

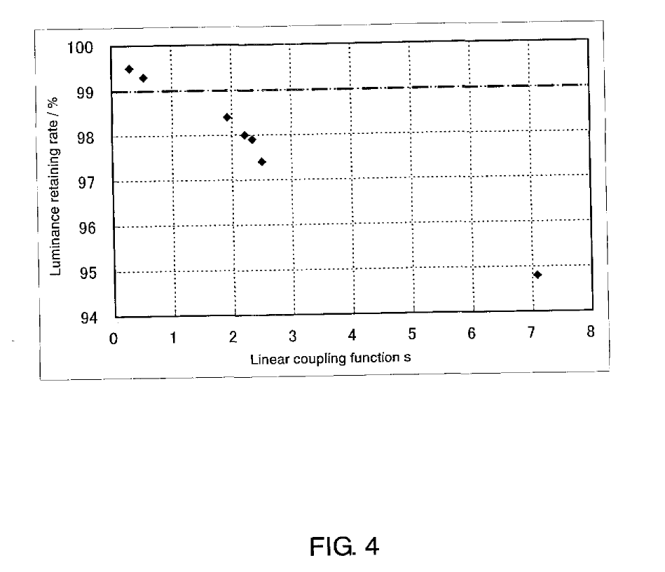

A graph relating the luminance retaining rate on the vertical axis to the linear coupling function s on the horizontal axis is shown in FIG. 4.

As shown in Table 4 and FIG. 4, it is found that an excellent luminance retaining rate that is 99% or more is obtained when the value of the linear coupling function s is 1 or less. By using a blue phosphor having a luminance retaining rate of 99% or more, a light-emitting device in which a resistance to luminance degradation is excellent and a chromaticity change hardly occurs can be achieved. Furthermore, since the occurrence of a burn-in phenomenon, which may occur along with long-term consecutive display of a fixed image, is prevented, a plasma display panel that exhibits an excellent display performance can be achieved.

The reason why the correlativity between the value of the linear coupling function s of the aluminate phosphor and the luminance retaining rate is high is not exactly known, while the reason why the influence of Lₐ, L₁ and L₂ is strong is presumed as follows. First, Lₐ has strong relationship with an interatomic distance between O(1) and Ba(Eu) on a so-called mirror plane, and L₁ is originally an interatomic distance between Al(2) close to the mirror surface and O(5), which is an oxygen closest to Ba(Eu). Therefore, both of them relate closely to a movement to Eu, which is an emission center of an electron-hole pair that is generated by vacuum-ultraviolet light. On the other hand, L₂ is an interatomic distance between Al(1) and O(4), and therefore, its influence should be small, judging from common knowledge. However, as described above, its influence is strong. This reason is presumed that it is caused by the fact that a part of Eu can replace Al(1) sites (see e.g., Journal of Electroceramics, vol. 10, p. 179-191, (2003)).

### INDUSTRIAL APPLICABILITY

The present invention can apply to various light-emitting apparatuses that use a phosphor layer containing a blue phosphor. As these apparatuses, for example, a plasma display panel, a fluorescent lamp, a fluorescent panel used as a backlight of a liquid crystal display device and the like are mentioned.

1. A light-emitting device which is provided with a phosphor layer containing a blue phosphor,
wherein the phosphor layer includes an aluminate phosphor, as the blue phosphor, that contains Ba, Sr, Eu, Mg, Al and O as constituting elements at an atom-number ratio Ba:Sr:Eu:Mg:Al:O=p:q:r:1:w:17 wherein 0.707≦p≦0.95, 0≦q≦0.15, 0.05≦r≦0.20, p+q+r≧1, and 9.8≦w≦10.5 are satisfied, and
a value of a linear coupling function s represented by a formula:
s=−11622+2043.07Lₐ1199.24L₁−116.91L₂
is 1 or less, when a lattice constant is Lₐ(Å), an interatomic distance between Al(2) and O(5) is L₁(Å), and an interatomic distance between Al(1) and O(4) is L₂(Å), which are obtained by an X-ray crystal structure analysis assuming that the aluminate phosphor belongs to a space group P6₃/mmc, wherein the Al(2) is the aluminum that is in the 4f site and the polarization coordinate z of which is approximately 0.17, the O(5) is the oxygen that is in the 12k site and is closest to the Al(2), the Al(1) is the aluminum that is in the 4f site and a polarization coordinate z of which is approximately 0.02, and the O(4) is the oxygen that is in the 12k site and is closest to the Al(1).

2. The light-emitting device according to claim 1, wherein the aluminate phosphor is substantially an aluminate phosphor that is represented by BaₚSr_{q}EuᵣMgAl_{w}O₁₇.

3. The light-emitting device according to claim 1,
wherein the aluminate phosphor is substantially an aluminate phosphor wherein at least one element selected from the group consisting of Nb and W is added to BaₚSr_{q}EuᵣMgAl_{w}O₁₇, and the total amount of the at least one element is 0.3 mol or less relative to 1 mol of the BaₚSr_{q}EuᵣMgAl_{w}O₁₇.

4. The light-emitting device according to claim 1, wherein the light-emitting device is a plasma display panel, a fluorescent lamp, or a fluorescent panel.

5. The light-emitting device according to claim 4, wherein the light-emitting device is a plasma display panel.

6. The light-emitting device according to claim 5,
wherein the plasma display panel has a construction comprising: a front panel, a back panel that is arranged to face the front panel, barrier ribs that define the clearance between the front panel and the back panel, a pair of electrodes that are disposed on the back panel or the front panel, a discharged gas that is present at least between the electrodes and contains xenon that emits vacuum ultraviolet ray by applying voltage between the electrodes, and phosphor layers that emit visible light induced by the vacuum ultraviolet ray,
and a blue phosphor layer of the phosphor layers contains the blue phosphor.

7. The light-emitting device according to claim 2, wherein the light-emitting device is a plasma display panel, a fluorescent lamp, or a fluorescent panel.

8. The light-emitting device according to claim 3, wherein the light-emitting device is a plasma display panel, a fluorescent lamp, or a fluorescent panel.
